(19) United States
(12) Patent Application Publication
(10) Pub. No.: US 2010/0293796 A1
(43) Pub. Date: Nov. 25, 2010

(54) SAFETY CUTTING BLADES AND KNIVES

(75) Inventor: Earl Votolato, Newport Beach, CA (US)

Correspondence Address: FISH & ASSOCIATES, PC;ROBERT D. FISH, 2603 Main Street, Suite 1000, Irvine, CA, 92614-6232, US

(73) Assignee: EARL & KIMBERLY VOTOLATO LIVING TRUST, Newport Beach, CA (US)

(21) Appl. No.: 12/470,841

(22) Filed: May 22, 2009

(51) Int. Cl. B26B 29/00

(52) U.S. Cl. 30/287

(57) ABSTRACT

Safety cutting blades and utility knives having such blades are presented. Safety cutting blades include safety features that protect users from contacting a cutting edge. Preferred blades comprise a stem and a cross bar that orthogonally intersects with the stem. One or more cutting edges can be disposed within a notch made into an edge of the blade. Safety features can include safety guards located at one or more ends of the cross bar where the safety guards cooperate with the stem of the blade to form the notches. The notches can be sized and dimensioned to reduce a risk of a body part from contacting a cutting edge.

### FIELD OF THE INVENTION

The field of the invention is cutting blade technologies.

### BACKGROUND

Utility knives come in all sorts of sizes and shapes depending on their purposes. Providers of utility knives often manufacture a general purpose knife capable of being used for most cutting tasks. However, a general purpose knife is likely expensive, or unsafe for specific, dedicated tasks. Knives that are manufactured for a specific task can be made inexpensively while also ensuring that the user remains safe from exposed cutting edges of an attached blade.

Consider for example the knife described in U.S. patent application publication 2009/0056145 to Alfi et al. titled “Double-Bladed Knife” (March 2009). The knife disclosed by Alfi has exposed cutting edges that could be use for many purposes. However, when the knife is used for a specific cutting task, cutting twine or string for example, a user could easily injure themselves on the cutting edges. In a similar vein, U.S. Pat. No. 6,473,973 to Ireland titled “Knives” (November 2002) describes a two bladed knife where the blades are placed in close proximity to each other to provide some level of protection to a user. The Ireland knife provides for a more dedicated purpose, removing molding or flashing, but still requires a knife that has many exposed cutting edges.

A better knife would be inexpensive to produce, have reduced cutting edges that are more appropriately focused on a desired cutting task, and would provide some protection to the user from the cutting edges. For example, a utility knife dedicated to cutting, ripping, or severing packaging material might have guarded, hooked blades. Such a knife appears to be contemplated by U.S. design Pat. Nos. 521,844 titled “Cutter” (May 2006) and 527,604 titled “Cutter” (September 2006) both to Kempker. The Kempker cutters appear to be similar to the knife presented in FIG. 1.

In FIG. 1, a dedicated knife comprises a traditional blade 100 having a straight cutting edge 110. The solid lines represent blade 100 and dashed lines represent handle 120 of a knife. Blade 100 can be embedded into a handle where portions of cutting edge 110 are covered to provide some protection against injury, while only small portions of cutting edges 110 remain exposed for cutting twine, string, paper, or other materials. Unfortunately, several problems arise with such a configuration.

One issue associated with the configuration presented in FIG. 1 is that traditional blade 100 can easily pivot, slide, or otherwise move with respect to handle 120 when under a cutting force in an unintended manner. This is especially problematic when the material to cut offers high resistance to cutting, even when blade 100 is held by a screw or bolt through the center of the blade. The use of traditional blade 100 is undesirable for a knife having such a dedicated purpose because the blade could easily come loose and injure a user due to the extensive cutting edge 110.

Yet another problem arises from a covering material applied over blade 100. As cutting edge 110 is pulled across a material, a flat sheet of thick paper or rubber for example, the two sections of the cut material must separate to pass over the covering material behind the exposed portions of cutting edge 110, which increases the effort required to cut the material. This is especially true for corrugated cardboard, plastics, rubber sheets, or other stiff materials.

U.S. patent application publication 2007/0283576 to Saiz titled “Cutting Tool for Composition Shingles” (December 2007) also illustrates several of the above issues. The contemplated blades are pivotally attached to handle, which would be unsuitable for use in a utility knife. Still, the Saiz cutting tool contemplates that a blade could have two or four cutting edges dedicated to cutting shingles. While Saiz, would be unsuitable for a utility knife, Saiz does make some progress by having small dedicated cutting edges. U.S. Pat. No. 6,195,896 to Ireland titled “Safety Knife” (March 2001) addresses some of the deficiencies of Saiz. For example, Ireland describes a double-ended hooked blade, again with smaller cutting edges, where the cutting edges can be shielded or covered to prevent injury. However, even Ireland's approach represents an expensive solution for a dedicated knife. One should also note that the above references, and others, fail to provide for blade where the blade itself provides safety features. Rather a knife handle provides safety features.

The above references and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

What has yet to be appreciated is that a utility knife can be manufactured inexpensively that also provides a reduced risk of accidental injury by using a blade that is constructed with safety features as opposed to merely including safety features into a knife body or handle. For example, a safety cutting blade can include a stem, a cross bar, and a cutting notch that cooperate to protect a cutting edge located within an interior portion of the cutting notch. In some configurations that safety cutting blade can comprise a T-shaped blade, an L-shaped blade, or other desirable shapes. A safety cutting blade can be affixed to a handle of a knife where the safety cutting blade can have two distinct cutting edges located at the interior portion of an intersection of the cross bar and the stem. Protection can be provided by safety guards extending from the cross bar. Furthermore, the stem of the safety cutting blade can be securely coupled to the handle in a manner that prevents undesirable movement of the blade during use.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

The issues discussed above represent a small subset of issues of a larger set of issues with traditional utility knives. Thus, there is still a need for safety cutting blades that provide one or more safe cutting edges, to address one or more of the above issues, or other issues with traditional utility knives.

### SUMMARY OF THE INVENTION

The inventive subject matter provides apparatus, systems and methods in which safety cutting blade comprises a stem and an intersecting cross bar. On aspect of the inventive subject matter includes a safety cutting blade that where cross bar preferably ends with a safety guard that cooperates with a portion of the stem to form a cutting notch. An interior portion of the notch preferably comprises at least one cutting edge that is located at an intersection of the cross bar and stem. In a preferred embodiment, the cutting notch is defined by the non-cutting edges (e.g., blunted, rounded, etc.) of the stem and safety guard. Other non-cutting edges of the safety cutting blade are preferably rounded for additional safety. For example, non-cutting edges of the cross bar, the safety guards, the stem, the corners, or other edges can be rounded.

The safety cutting blade can also include a second cutting edge disposed in a second cutting notch on an opposite side of the blade stem, also preferably protected by a safety guard extending from the cross board. Furthermore, it is also contemplate that a cutting notch could include two or more distinct cutting edges.

In some configurations a safety cutting blade can comprise an L-shaped blade or even a T-shaped blade, where the blade can be symmetric or asymmetric. Furthermore, cutting edges of the safety cutting blade can be oriented for cutting via a pushing force directed along the stem of the blade toward the head of the stem, or cutting via a pulling force directed along the stem toward a foot of the stem. Suitable safety cutting blades can be made of materials capable of carrying a cutting edge including metals, steels, plastics, wood, ceramics, or other acceptable materials.

Another aspect of the inventive subject matter includes a utility tool that incorporates a preferred safety cutting blade into the handle of the tool. Via the safety cutting blade the tool can be configured to cut, rip, or otherwise sever a material in a safe manner.

In a preferred embodiment, the T-shaped blade includes one or more guiding “safety guards” that extend beyond the cutting edges and parallel to the body of the knife. Preferably the safety guards cooperate with the body of the knife to guide a material to the cutting edges when the knife is pushed through the material or pulled through the material. The safety guards of the T-shaped blade can also provide protection against accidental injury to the user of the knife. Furthermore, the safety guards on either side of the T-shaped can extend in opposing directions, or can even be asymmetric.

Although a preferred embodiment employs a unitary T-shaped blade, it is also contemplated that the blade could have other properties. For example, the T-shaped blade could comprise at least one L-shaped blade, more preferably at least two, disposed at the working end of the knife. It is also contemplated the T-shaped blade could be manufactured as part of the handle of the knife. The blade can be permanently attached to the tool handle to form a utility knife, or can be part of a tool bit cartridge configured to releasably attach to the handle.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a prior art cutter having a traditional blade.

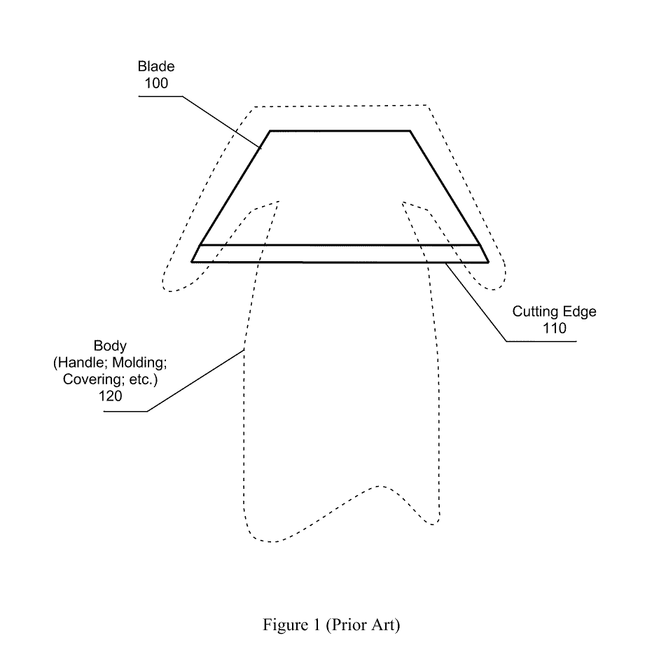

FIG. 2A illustrates various features of safety cutting blade.

FIG. 2B illustrates other potential safety cutting blade features.

FIG. 3A illustrates yet another possible embodiment of a safety cutting blade where edges are curved.

FIG. 3B illustrated another embodiment of a safety cutting blade with a shortened stem and notched anchor points.

FIG. 3C illustrates other possible embodiments of safety guard and notch configurations.

FIG. 3D illustrates possible configurations of cross sections for a safety guard and a cross bar.

FIG. 4 presents a top and side view of a possible utility knife having a safety cutting blade.

FIG. 5 presents another possible embodiment of a utility knife having a safety cutting blade carried by a removable cartridge.

FIG. 6 illustrates possible configurations of utility knives where a safety cutting blade has been placed in a body of the knives.

FIG. 7 illustrates possible embodiments of utility knives with safety cutting blade in open and closed positions.

### DETAILED DESCRIPTION

The inventive subject matter is presented within the scope of a safety cutting blade disposed within a utility knife having a dedicated purpose of cutting, ripping, or otherwise severing materials via pulling or pushing the knife. However, one should note that the inventive subject matter can be easily extended to multi-purpose tools. For example, a tool-bit cartridge could be manufactured having the contemplated blades where the cartridge could be coupled to a handle of the multi-propose tool. Additionally, the contemplated knives could have one or more other tool bits disposed about the handle.

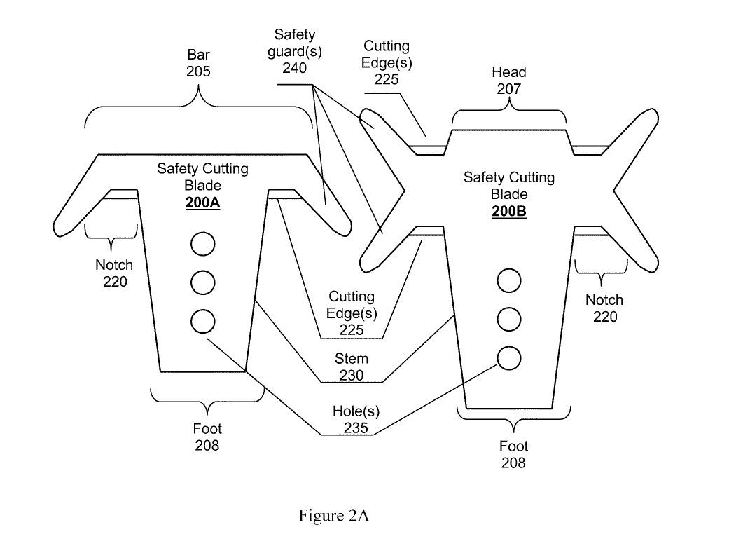

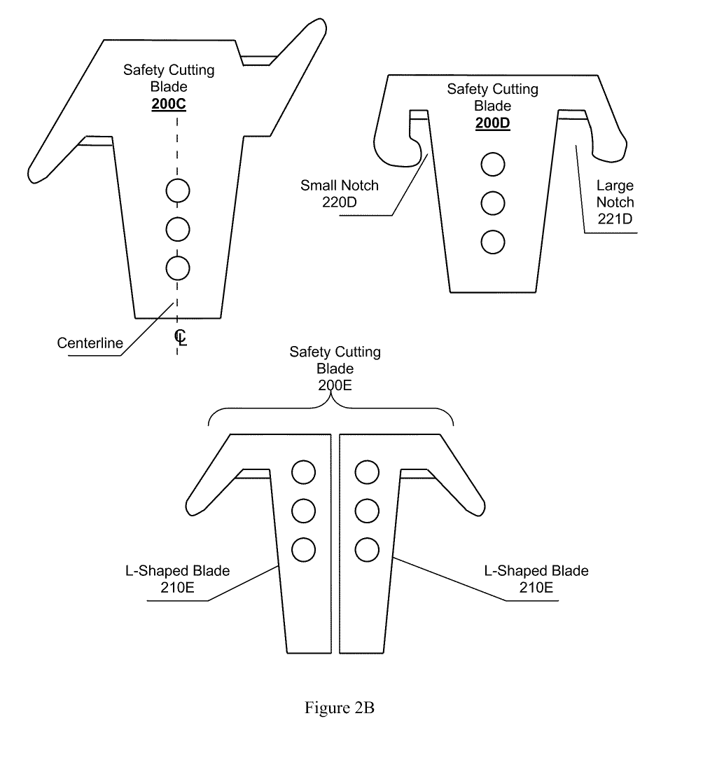

FIG. 2A and 2B present features of contemplated of safety cutting blade 200A through 200E, collectively referred to as safety cutting blade 200. Each of blades 200B through 200E, 300A, and 300B comprises core blade features as represented in blade 200A. The other safety cutting blades include additional features or characteristics beyond those of 200A. One should note that the presented features of blades 200 could vary widely from the features presented in FIGS. 2A and 2B depending on the desired purpose or configuration of a contemplated utility knife.

Safety cutting blade 200A illustrates several preferred features of a safety cutting blade and is presented in the form of a T-shaped blade for clarity purpose. Preferred blades comprise cross bar 205, referred to as simply bar 205, capping the top of stem 230 of blade 200A and have at least a first end and possibly a second end on an opposing side of stem 230. Bar 205 is approximately orthogonal to stem 230 and intersects stem 230 at head end 207 of stem 230. Bar 205 preferably comprises one or more safety guards 240 that operate as a quillon to protect a user from accidentally contacting cutting edges 225. As shown, blades 200 can include a first safety guard 240, a second safety guard 240, or more of safety guard 240.

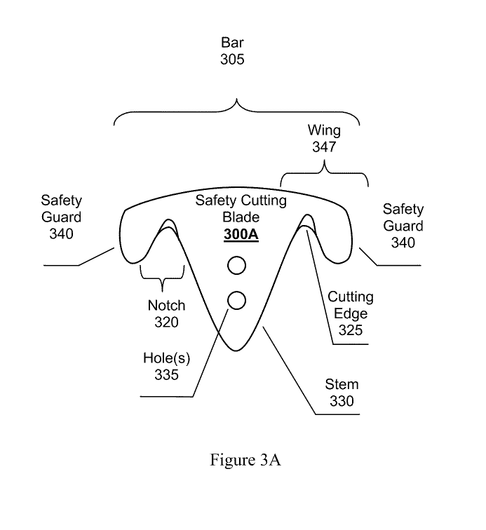

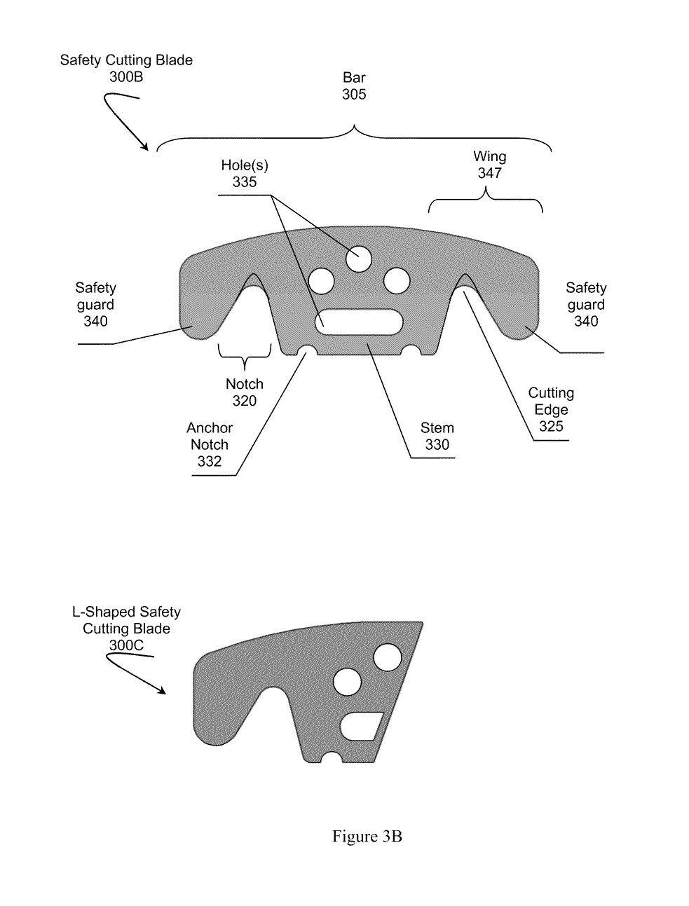

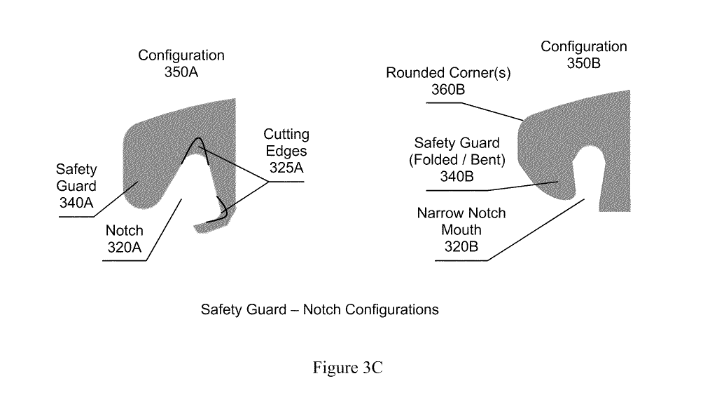

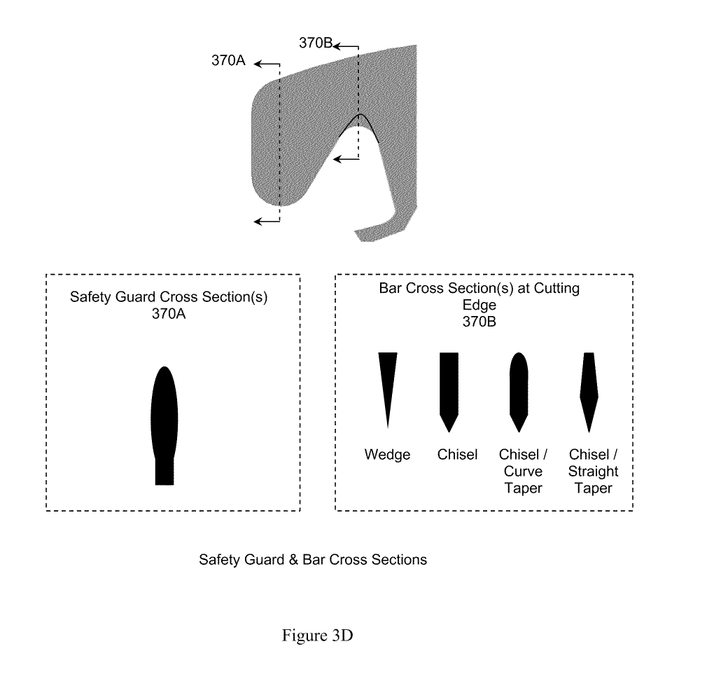

In a preferred embodiment, stem 230 extends from bar 205 further than safety guards 240 where stem 230 preferably has a length that is greater than the length of safety guard 240 as measure from the bottom of cutting edge 225. Stem 230 is shown with an exaggerated length for clarity. In some embodiments, stem 230 is at least half the length of bar 205, and or even same length as bar 205, or even having a greater length. However, in some embodiments, stem 230 can be quite short (see FIG. 3B).

Blades 200 also compromise one or more anchor points represented as holes 235, preferably located on stem 230, or on bar 205. Holes 235 can be used to anchor blades 200 within a handle of a knife when stem 230, operating as a tang for blades 200, is inserted or otherwise coupled to a knife handle. For example, screws, bolts, pins, or even molded plastic can anchor blades 200 to a knife handle by passing through holes 235. Although the anchor points of blades 200 are illustrated as holes, one should appreciate that other anchor points can also be employed in blades 200. For example, anchor points can be holes as shown, notches in the edge of stem 230 (see FIG. 3B), protrusions (e.g., pins, hooks, etc.) extending out of the general plan of blades 200, or other anchor points.

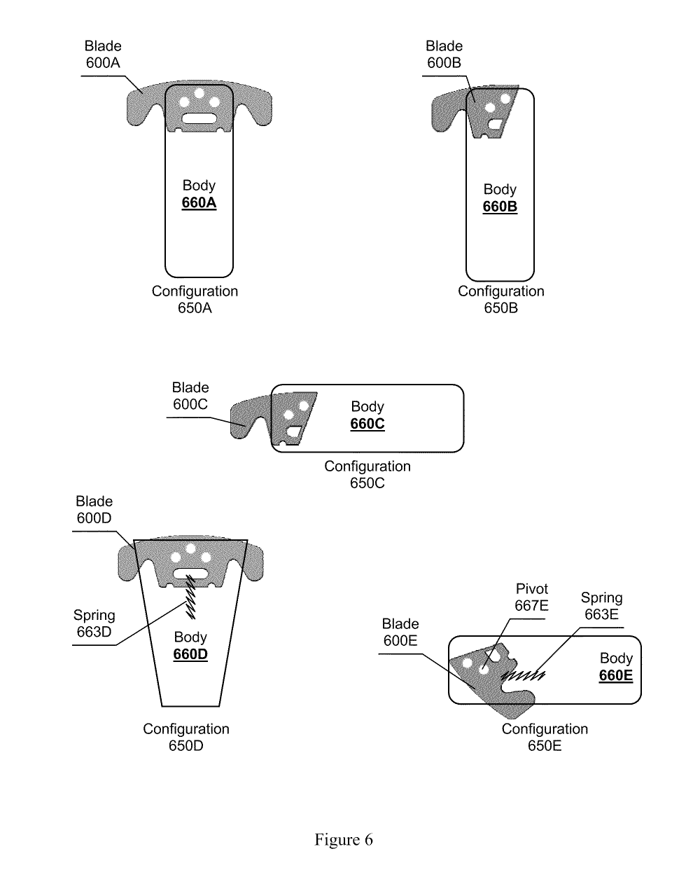

Preferred blades 200 comprise two or more anchor points (e.g., at least two of holes 235) to ensure that blades 200 can be securely attached to a knife handle. It is considered desirable to have more than one anchor point to ensure that a blade 200 is restricted from pivoting during use while under the stress of a pushing or pulling cutting force in embodiments where pivoting or sliding is undesirable. In other embodiments, pivoting or sliding might have advantages (see configuration 650E of FIG. 6).

In a preferred embodiment, safety cutting blades 200 include one or more of safety guards 240 that extend approximately beyond cutting edges 225. Preferred safety guards 240 are roughly within the general plane of blades 200 and extend approximately parallel to stem 230, toward foot 208 of stem 230 or toward head 207 of stem 230 as shown in safety cutting blades 200B.

Preferably blades 200 comprise at least two distinct cutting edges 225, where preferably at least two of cutting edges 225 are located at an intersection of stem 230 and bar 205, preferably at an interior intersection, as shown in blade 200A. For example, blade 200A has a second cutting edge 225 disposed within a second notch 220 opposite to a first notch 220 relative to stem 230. Cutting edges 225 represent separate sharpened edges that are preferably disposed on opposing sides of stem 230, or separated by stem 230 or possibly head 207 of stem 230. Blades 200 can include two or more safety guards 240 disposed on opposing sides of bar 205. Such an arrangement allows a user to cut a material by pulling a knife in the direction in which stem 230 extends toward foot 208 of stem 230. In a preferred embodiment, the non-cutting edges of blades 200 other than cutting edges 225 are unfinished, unsharpened, blunted, rounded, or otherwise configured to be safe to touch.

In other embodiments, cutting edges 225 can also be placed at an exterior intersection in a notch 220 possibly defined by edges of head portion 207 of stem 230 and upper safety guards 240, as shown in safety cutting blades 200B. Cutting edges 225 placed at the “top” of a safety cutting blades provides for cutting a material via applying a pushing force directed along the length of stem 230 toward head 207.

Regardless of the location of cutting edges 225, preferred cutting edges 225 have a limited extent to reduce the risk of injury. Preferred cutting edges 225 are less than about quarter the length of bar 205. However, the length can be adjusted depending on target material to be cut.

In a preferred embodiment, cutting edges 225 are disposed within notches 220 defined by safety guards 240 and stem 230. Safety guards 240 provide many useful functions. One useful function includes safety guards 240 operating as a guiding surface to funnel a material to cutting edges 225 as blades 200 are pushed or pulled across the material. Another function provided by safety guards 240 includes providing a safety guard to prevent a user's body part from entering notch 225 and contacting cutting edges 225. Safety guards 240 can be sized and dimensioned to ensure that notch 220 prevent a body part from entering a cutting area.

It is also contemplated that safety guards 240 could be pivotally or hingedly coupled to stem 230 or bar 205. In some embodiments, safety guards 240 can be spring loaded in a manner where safety guard 240 is biased closed against stem 230 or even a body of a knife handle, thereby closing notch 220. As a material is guided toward cutting edge 225, the material can push safety guard 240 open, thus opening notch 220 and allowing the material to be cut by cutting edge 225. It is also contemplated that safety guards 240 could even fold into a handle of a knife, if desired.

Blades 200 can be generally planar, and have a thickness suitable for cutting a target material. For cutting stiff materials (e.g., corrugated cardboard, thick paperboard, rubber sheets, plastic, etc.), blade 200 is preferably thin so that the stiff material is not required to flex substantially as it passes over bar 205 while the material is cut. Having a thin blade or at least a thin portion near cutting edges 225 reduces friction and eases cutting. Blades 200 having a thickness of no greater than 0.3 millimeters would be suitable for such use. Other target material to be cut (e.g., string, twine, paper, etc.) could be cut by thicker blades.

Safety cutting blades 200A illustrates a set of basic features of a preferred safety cutting blades common to the blades presented herein, while safety cutting blade 200B comprises additional, possibly optional, features. For example, safety cutting blade 200B could have optional head 207 on stem 230 that form notches 220 on the “head” part of blade 200B. Head 207 and a safety guard 240 cooperate to form guiding surfaces that can help funnel a material to cutting edges 225. Safety cutting blade 200B also illustrates an embodiment having at least four cutting edges that are distinct, preferably separated by bar 205 or stem 230. Safety cutting blade 200 can include yet more features.

In FIG. 2B, for example, blade 200C is asymmetric about a centerline running the length of its stem. One of the cutting edges of blade 200C is positioned for cutting by a pushing force, and a separate, distinct cutting edge of blade 200C is position for cutting by a pulling force. Blade 200D is also asymmetric. Blade 200D has small notch 220D and large notch 221D, possibly configured for cutting different materials, different shaped materials, or different thicknesses of materials. Blade 200D also has preferred rounded safety guards, where the non-cutting edge tips of the safety guards are configured to be safe to touch. Also note that the safety guards can protrude “inward” toward an interior portion of notch 220D to form a narrow mouth to prevent a user from accidentally introducing a body part into the cutting area.

Although notches are shown at intersecting location of a blade's cross bar and stem, one should note that notches can also be located else where. Preferred notches are defined by two or more non-cutting edges, preferably blunted or unsharpened, disposed on either side of a cutting edge. In some embodiments, notches can be solid disposed in a blade stem, a blade body, a cross bar, or other location about the blade.

Safety cutting blade 200E illustrates yet another embodiment of a safety cutting blade. Safety cutting blade 200E comprises at least two distinct sub-blades. When combined, blades 210E form a desirable T-shaped structure. In the example shown, safety cutting blade 200E comprises at least one L-shaped blade, and preferably a second L-shaped blade 210E. One should note that composite safety cutting blade 200E retains the basic features discussed above.

One should appreciate that blades 200A through 200E are presented for discussion and that actual blades can very widely from those depicted. For example, the various edges or surfaces of blades could be curved, vary in thickness, have different cross sections, or have other features.

An example blade having curved surfaces includes blade 300A as illustrated in FIG. 3A. Although blade 300A has a different form than those presented previously, it still retains desirable core features, for example stem 330 can also have anchor points (e.g., holes 335). Each of the various surfaces of a safety cutting blade can be curved if desired. Curved edges provide several additional benefits. One benefit is that curved, unsharpened, or blunted edges are thought to be less likely to get caught accidentally on loose surrounding materials (e.g., clothing, material to be cut, etc.). Curved cutting edges 325 also provide a benefit of further funneling or guiding material to be cut toward the a desirable spot on sharpen cutting edges 325, as opposed to a straight cutting edge that allows a material to slide back and forth across the edge, which can cause an uneven cut. As shown, safety guards 340, wing 347, stem 330, bar 305, or even notch 320 can be curved. In a preferred embodiment, most curved edges are convex edges, expect for cutting edges 325 which are preferably concaved.

In FIG. 3B, safety cutting blade 300B illustrates yet more potential features. As with blade 300A, the various edges of the blade 300B are curved. Blade 300B has some differences. For example, blade 300B illustrates different forms of anchor points, which can include holes 335 or anchor notch 332. One should note that anchor holes 335 can include elongated holes, or holes of different shapes beyond mere circles including elongated holes, ellipses, squares, triangles, pentagons, or even irregular polygons. Non-circular anchor points are considered to be advantageous as they are thought to provide additional resistance to torque on the safety cutting blade 300B when in use.

FIG. 3B also presents safety cutting blade 300C having a moderate L-shape. Blade 300C is similar in most respects to blade 300B with the exception that it has a single cutting notch as opposed to two or more cutting notches.

FIG. 3C provides additional contemplated configurations 350 of cutting notches and safety guards. In configuration 350A, notch 320A has a slightly narrow mouth and includes at least two distinct cutting edges 325A, preferably disposed at corners of notch 320A. It is contemplated that cutting notch 320A could include various configurations supporting multiple, distinct cutting edges. For example, a first cutting edge 325A, a second cutting edge 325A, or more cutting edges 325A could be disposed within an interior portion of notch 320A. It is also contemplated that an interior portion of notch 320A could comprise additional novel features including protruding edges (not shown) that separate multiple cutting edges 325A and that operate as guides to funnel a material to a desired cutting edge 325A. Configuration 350A also illustrates that a stem of a blade can comprise a protruding edge that flairs toward safety guard 340A to aid in forming a narrow mouth opening for notch 320A.

Configuration 350B illustrates yet additional possible features of a safety blade. In configuration 350B, corners 360B have been rounded for additional safety to reduce risk of injury to the user, becoming caught on loose materials, or accidentally puncturing material. In a preferred embodiment, all non-cutting edges are rounded and all corners are rounded. Configuration 350B also illustrates that safety guard 340B can be configured to form narrow notch mouth 320B by protruding inward toward the interior portion of notch 320B. Also note that an edge of the blade's stem can also be angled inward toward safety guard 340B to cooperate a narrow notch mouth 320B.

Safety guard 340B can be made to protrude inward using numerous different methods. In some embodiments, the blade having safety guard 340B can be simply cut from a sheet of metal having a desired shape. In other embodiments, the blade having safety guard 340B can be molded or shaped o have the desired shape from a plastic, ceramic, die cast metal, wood, or other moldable materials. In yet other embodiments, blade guard 340B could be formed by bending or folding over a tab of blade material folded over on itself where safety guard 340B is folded toward the stem of the blade. The fold is preferably at an angle greater than 90 degrees to ensure the notch mouth 320A is formed. More preferably the fold angle is greater than 135 degrees, and yet more preferably is approximately 180 degrees.

Safety cutting blade 200, 300A, or 300B can be manufactured from any suitable material capable of carrying a cutting edge. Preferred safety cutting blades are formed from sheets of steel, possibly stamp cut. Other contemplated safety cutting blades can be made from other material that can carry a cutting edge including ceramics, hard plastics, the same material used to form a knife handle, or even hard woods (e.g., bamboo, etc.). The material can be varied to fit a target use of the blade. In embodiments where a utility knife is intended to be disposable, blades can be made of less durable materials (e.g., plastics, PVC, wood, etc.) for safety reasons.

In some embodiments, safety cutting blades substantially comprise (e.g., at least 90% by volume) a single material. It is also contemplated that safety cutting blades can be a composite of one, two, three, or more different materials. For example, a first material (e.g., metal) could be used to form the main parts of the blade including the stem, the cross bar, the safety guard, or cutting edges. A second, different material (e.g., a plastic, resin, epoxy, rubber, etc.) can be used to form a protective coating over at least some of the surfaces of the blade. A blade provider might include a coating over the cross bar to prevent corrosion, or to provide additional padding over the safety guards.

One should appreciate that safety cutting blades do not necessarily have to be generally planar objects where the bar, the stem, and the safety guards are co-planar, but can comprise surprisingly complex shapes. For example, FIG. 3D illustrates possible cross sections 370A for a safety guard and 370B for a cross bar at a cutting edge. Safety guards can be manufacture to include rounded surfaces as represented by cross section 370A for safety purposes. Additionally, a cross bar of a safety cutting blade could be manufactured to have different cross sections 370B at a positing of a cutting edge. Cross section 370B could have a shape of a wedge, a chisel, a chisel with a curved tapered back end, a chisel with a straight tapered back end, or other shapes. Cross sections 370B are presented with exaggerated widths and are not to scale to clearly represent features of the cross sections.

It is thought that cross sections 370B can be configured to best suit a cutting purpose. For example, in embodiments where cross section 370B has a tapered back-end, it is thought that the taper reduces drag or coefficient of friction for making long cuts through a sheet of flexible material (e.g., rubber, plastic, cardboard, etc.) by allowing the material to relax back into an non-flexed position after being cut.

Desirable cross sectional shapes for safety cutting blades can be formed using different methods including molding a blade to have desired shape, milling a blade material into a desired shape, folding a blade material, casting a blade, or other suitable methods that can be used to create an integral blade. It is also contemplate that desired shapes can be formed by over-molding or otherwise extending a material of a knife handle, or a blade cartridge, over a blade in a manner where the knife handle material provides desirable contours.

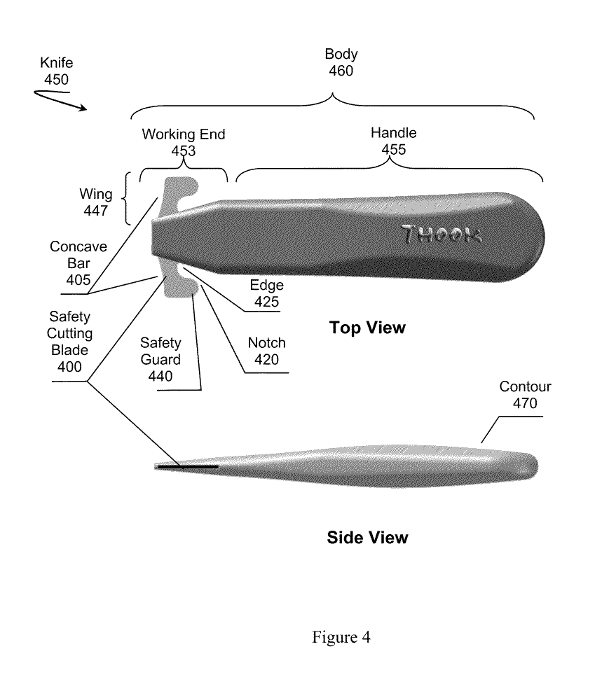

In FIG. 4, safety cutting blade 400 has been disposed within body 460 to form knife 450. A top view and a side view of knife 450 are presented. Knife 450 preferably comprises an elongated body 460 having a working end 453, in which blade 400 is placed, and a handle portion 455, by which a user typically grips knife 450. It should be appreciated that variations in the shape, size, or dimensions of contemplated knives can vary widely while still falling within the scope of the inventive subject matter. For example, handle 455 is shown as a unitary handle however, it could include one or more housing parts joined together to form handle 455. Handle 455 can also include one or more ergonomic contour 470. Additionally, handle 455 could comprise one or more looped grips (not shown), through which a user's finger can be inserted.

Body 460 can be manufactured from any suitable materials including wood, metal, plastics, ceramics, hard silicone rubber, or other materials, alone or in any combination. In a preferred embodiment, at least handle 455 can be formed as a single piece through injection molding. It is also possible that body 460 can be formed from multiple pieces that are joined together by thermal welding, chemical bonds, mechanical fasteners, or other means.

Blade 400 is illustrated as having slightly concaved non-cutting edges. The configuration of the features shown confers several benefits and is not mere design choice. Wings 447 of bar 405 have a reduced width (e.g., in the direction along body 460) relative to safety guard 440 and the portion of bar 405 closest to body 460. The reduced width allows a cut stiff material to slide over bar 405 and return to a non-flexed position after cutting, which reduces effort required to continuously cut the material as discussed above with respect to cross sections 370B. Such an approach is considered useful for cutting stiff materials including corrugated cardboard, thick paper board, plastic sheets, rubber sheets, or other stiff materials.

In a preferred embodiment, a safety cutting blade 400 is affixed to knife 450 at working end 453. Blade 400 can be affixed through in any suitable manner that befits the materials involved. A preferred method of affixing blade 400 to working end 453 includes molding body 460 around blade 400 in a manner where knife 450 represents a unitary assembly where blade 400 is substantially permanently affixed at working end 453. Other contemplated methods of affixing blade 400 to body 460 include mechanical fasteners (e.g., bolts, screws, snaps, dovetails, slides, cartridges, etc.), chemical fasteners (e.g., glues, adhesives, etc.), or even via a thermal fasting scheme (e.g., melting, etc.), preferably holding blade 400 in position via one or more anchor points.

Preferably elongated body 460 substantially covers a stem portion of safety cutting blade 400 by at least working end 453 to ensure that blade 400 is properly restrained from pivoting, sliding, or otherwise moving relative to body 460 while under a cutting force. In some embodiments, the working end 453 of body 460 extends beyond the stem of blade 400 to cover a portion of bar 405. In yet other embodiments, as shown, working end 453 extends beyond bar 405 and covers an outer edge of bar 405.

One specially preferred method of affixing blade 400 includes the use of a releasable cartridge. Blade 400 can be disposed in a removable cartridge that can be inserted or otherwise coupled to handle 455. Example cartridge-based tools are discussed in co-pending applications Ser. No. 12/319677 titled “Disposable Blade Cartridge Utility Knife” (filed Jan. 9, 2009), Ser. No. 12/391729 titled “Utility Tool Having Interchangeable Tool Cartridges” (filed Feb. 24, 2009), and Ser. No. 12/419827 titled “Tool Holster with a Tool Bit” (filed Apr. 7, 2009). Contemplated cartridges can mechanically couple to handle 455 (e.g., via latches, hooks, screws, bolts, etc.), where a cartridge can insert into, or snap onto handle 455.

It is also contemplated that knife 450 could be a single, integral unit rather than an assembly where blade 400 comprises the same material as body 460. In such an approach, the entire knife could be made through an injection molding process where a mold defines a desired shape of body 460, working end 453, handle, 455 and safety cutting blade 400. An integral knife 450 could be made from nylon fiber, plastics, carbon fiber, metals, or other materials. Such an approach is desirable in embodiments where knife 450 is considered disposable, or would likely have a limited life span.

Safety cutting blade 400 preferably includes rounded safety guards 440, where rounded safety guard 440 can confer beneficial properties as previously discussed. One benefit from rounded safety guards 440 includes providing protection to a user where a user's body part is restricted from entering notch 420, or contacting cutting edge 425. In a preferred embodiment, safety guards 440 are sized and dimensioned in a manner where notch 420 is defined by the edges of safety guard 440 and body 460. Preferably notch 420 has a maximum opening width of less than 0.5 centimeters, and more preferably less than 0.25 centimeters. Of course, the opening width can vary depending on the target us of knife 450. The depth of notch 420 as measured from cutting edge 425 to the tip of safety guard 440, is preferably also less than 0.5 centimeter. However, the depth can be varied to better suit the target cutting material.

Another advantageous feature of rounded safety guards 440 is that they provide a guiding surface for a material to be cut. As a user draws knife 450 across a material (e.g., by pulling or pushing), the rounded non-cutting edges of safety guards 440 or even non-cutting edges of the stem of blade 400, guide or funnel the material toward cutting edge 425.

Safety guards 440 can include other optional features. The outer edges of safety guard 440 (e.g., away from body 460) can be blunted, or can be made to have a greater thickness than the rest of blade 400 as discussed with respect to FIG. 3D. Blunting further reduces risk of injury to a user that might contact edges of safety guards 440. In some embodiments, safety guard 440 could be pivotally attached to bar 405, possibly in cooperation with one or more springs. In such an embodiment, safety guard 440 can be biased to close notch 420 when knife 450 is not in use. When a material approaches notch 420, the material can push safety guard 440 aside allowing the material to enter notch 420 and to contact cutting edge 425.

In a preferred embodiment, wing 447 remains substantially free from covering material to allow a cut material to pass freely over blade 400. Ensuring that wing 447 is free of additional cutting covering, reduces friction and eases a cutting operation. It is also contemplated, that only the center part of wing 447 aligned with cutting edge 425 is free from covering material, but the ends of wing 447 near safety guard 440 could be made thicker. The thicker wing ends and body 460 can operate as additional guiding surfaces that (1) guide a material toward cutting edges 425 as discussed above, or (2) guide cut material after being cut.

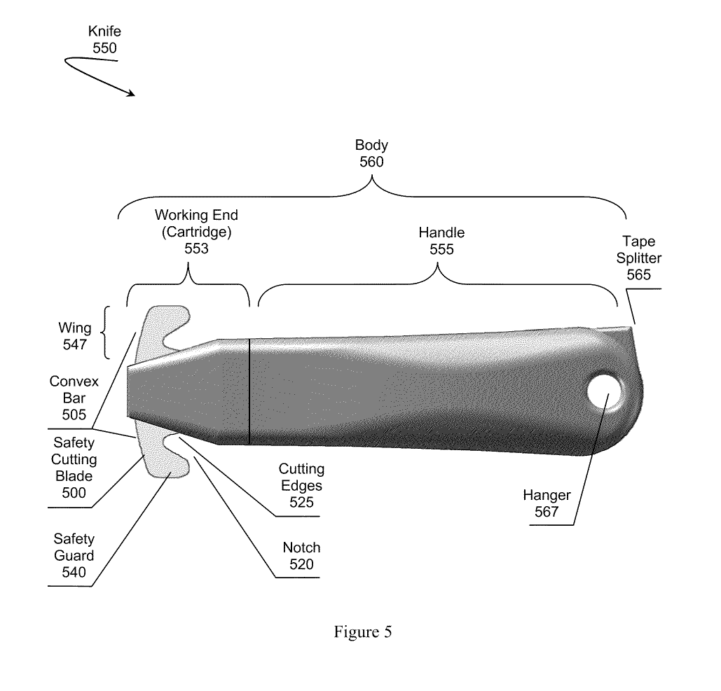

In FIG. 5, knife 550 represents another possible embodiment of a knife having a safety cutting blade 500, and illustrates other possible features. Similar to knife 450, knife 550 includes body 560 having working end 553 and handle 555, and safety cutting 500 having safety guards 540, cutting edges 525, and notch 520.

In the example shown, T-shaped blade 500 has several distinguishing features from T-shaped blade 400 of knife 450. One feature is that blade 500 comprises a convex bar 505 as opposed to a flat, or a concaved bar, which results in a wider wing 547. It some embodiments, having wider wing 547 provides additional strength to blade 500 when required for a target material to be cut. An additional feature includes that blade 500 has been disposed within a removable tool-bit cartridge that operates as working end 553. Knife 550 can also comprise optional features including tape splitter 565 or hanger 567.

One should also appreciate that in embodiments where blade 500 is disposed within a tool-bit cartridge, that knife 550 could be one instance of a multi-tool system. It is also contemplated that knife 550 could include other active tool-bits on handle 555 in additional to blade 500. For example, handle 555 could support a screwdriver bit at the distal end of handle 555 away from blade 500. In a preferred embodiment employing cartridges, working end 553 represents a removable blade cartridge for a utility tool.

FIG. 6 illustrates possible configurations 650 of safety cutting blade - knife body assemblies. Configuration 650A illustrates a nominal configuration where two-sided blade 600A (e.g., a T-shaped blade) is coupled to body 660A using any suitable means as previously discussed. Configuration 650B illustrates an embodiment were a single-sided blade 600B (e.g., an L-shaped blade) can be affixed to body 660B.

One should note that safety cutting blades can be affixed at different angles beyond those illustrated in configurations 650A and 650B. For example, configuration 650C illustrates an embodiment where blade 600C is affixed to body 660C approximately orthogonal to configuration 650B. It is specifically contemplated that safety cutting blades can be coupled at any desirable angle to meet requirements of an intended purpose, regardless of whether the blade is T-shaped, L-shaped, or other shape.

Configurations 650D and 650E illustrate yet other possible embodiments where safety cutting blades can be biased in a safe, closed position where cutting edges are safely covered. In the illustrated configurations 650D and 650E, blades 600D and 600E are biased into a closed or safe position, via a restoring force provided by springs 663D and 663E respectively. The springs should be interpreted to include any suitable mechanism for biasing blades into a safe position. Other examples of restoring forces can be exerted by elastic bands, elastomeric pads, magnets, coil springs, or other devices. In a preferred embodiment, cutting edges of blades remain safely covered when not cutting. Cutting edges can be covered by a body of the knife, by a blade cartridge, by a blade guard, or other suitable covering.

With respect to configuration 650E, one should note that in some embodiments, blade 600E can be configured to pivot, possibly around an anchor point. In the example show, blade 600E pivots around pivot 667E under the force of spring 663E.

Although configurations 650 illustrate a blade coupled to a knife body, one should appreciate that the blades can also be part of a blade cartridge as previously discussed. In such configurations, springs 663D or 663E could couple to a cartridge housing, which in turn holds the safety cutting blade.

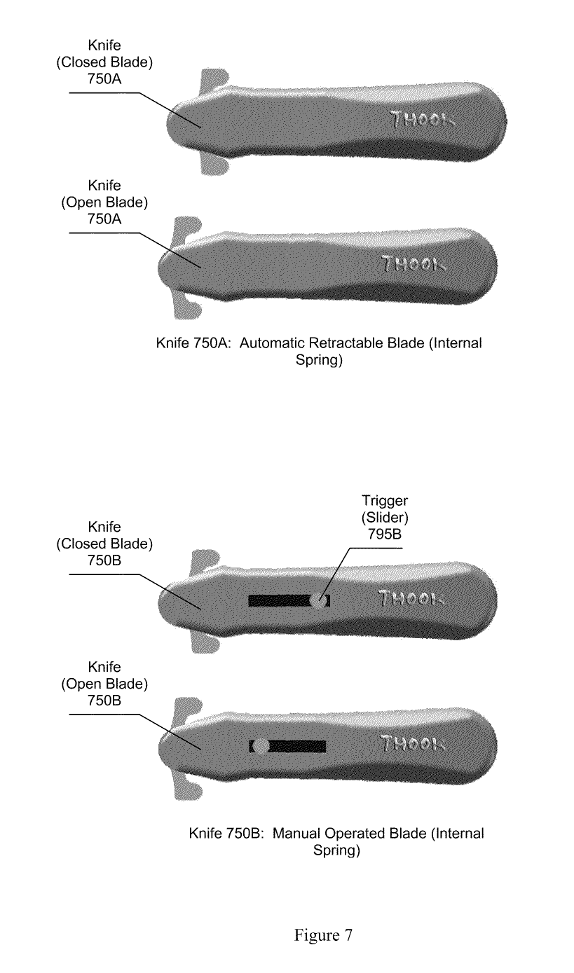

In FIG. 7, knives 750A and 750B represent more realistic embodiments of the inventive subject matter. Knife 750A illustrates an embodiment where a blade automatically retracts when not in use. Knife 750A comprises an internal spring (not shown), and has a configuration similar to that illustrated by configuration 650D. The internal spring biases the blade in a closed, safety position (top knife) when not in use. When in use, a force on the blade by a material to be cut applied at the opening of the cutting notch causes the blade to open thereby is exposing a cutting edge to the material. It should be noted that the safety guards of the blade aid in guiding a material to the cutting edge. It is also contemplated that the blade could pivot (see configuration 650E) only allowing a single cutting edge to open while causing an opposing cutting edge to retreat further into cover. Such an approach ensures only cutting edges that are in use are exposed.

Knife 750B illustrates a similar arrangement to knife 750A with the addition of one or more of trigger 795B shown as a slider that can be actuated to allow the blade to open. Trigger 795B can be position at any location about the handle of knife 750B. Furthermore, more than one (e.g., two, three, etc.) of trigger 795B can be positioned about the handle for use by right or left hands. Knife 750B can also include an internal spring (not show) that can substantially resist a force exerted by a target material. Additional force, possibly a person's thumb of finger, can be required to overcome the restoring force of the spring to allow the blade to open. In other embodiments, trigger 795B can cause a lock to be disengaged to allow the blade to open. Locks can include latches, springs, pawls, rods, or other assemblies that lock the blade into position. It is also contemplated that knife 750B could be configured to only allow one cut per actuation of trigger 795A. Example locking assemblies that can be adapted for use with the inventive subject matter can be found in co-pending patent application having serial number 12/391,729 titled “Utility Tool Having Interchangeable Tool Cartridges” filed on Feb. 24, 2009; co-pending patent application having serial number 11/621,208 titled “Utility Knife With Counter-Reciprocating Blade and Guard” filed on Jan. 9, 2007; co-pending U.S. patent application having Ser. No. 12/383,677 titled “Safety Cutting Apparatus” filed Mar. 27, 2009; co-owed U.S. Pat. No. 7,356,928 titled “Utility Knife with Safety Guard having Reduced Play”; or co-owned U.S. Pat. NO. 7,082,688 titled “Utility Knife with Dual Retractable Cutting Guides”.

The inventive subject matter is considered to include the following features for a utility tool comprising the contemplated blades:
a. The tool can comprise a unitary assembly (e.g., the blade is substantially permanently coupled to a tool handle), an assembly where blades are replaceable, or a blade cartridge assembly where the blade cartridges are replaceable.
b. The blades can be prevented from pivoting, or can allow for pivoting. It is especially contemplated that a blade having two distinct cutting edges can pivot during use to cover one of the cutting edges.
c. The tool can include an internal spring that couples to the blade or a blade cartridge to retract the blade into safety closed position where the cutting edges are covered, possibly by the knife body, blade cartridge, or other covering.
d. The blades can be configured to mate with different utility tool handles, possibly by advantageously positioning anchor points in the blades cross bar or stem, or by appropriable configuring a blade cartridge to have more than one mating interface.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. What is claimed is:

1. A safety cutting blade, comprising:
a body having a stem and a cross bar intersecting the stem at a head end of the stem, the cross bar comprising a first safety guard disposed at a first end of the cross bar, and where the stem has a length greater than that of the first safety guard;
at least a first cutting edge disposed within a first notch defined by non-cutting edges of the stem and the first safety guard; and
wherein at least some of non-cutting edges of the cross bar, the first safety guard, and the stem are rounded.

2. The safety cutting blade of claim 1, wherein the safety cutting blade comprises a second, distinct cutting edge disposed within a second notch that is (a) on an opposing side of the stem from the first notch, (b) is located at second intersection of the stem and bar, and (c) is defined by non-cutting edges of the stem and a second safety guard.

3. The safety cutting blade of claim 2, wherein the cross bar comprises the second safety guard disposed at a second end of the cross bar opposite of the first end.

4. The safety cutting blade of claim 3, wherein the safety cutting blade comprises a T-shaped blade formed from the cross bar, the stem, the first safety guard, and the second safety guard.

5. The safety cutting blade of claim 1, wherein the first safety guard extends from the first end of the cross bar approximately parallel to, and toward the head end of the stem.

6. The safety cutting blade of claim 5, wherein the first cutting edge is oriented for cutting a material via a pushing force directed along the stem toward the head end of the stem

7. The safety cutting blade of claim 1, the first safety guard extends from the first end of the cross bar approximately parallel to, and toward a foot of the stem.

8. The safety cutting blade of claim 7, wherein the first cutting edge is oriented for cutting a material via a pulling force directed along the stem toward the foot of the stem

9. The safety cutting blade of claim 1, wherein the first cutting edge is curved.

10. The safety cutting blade of claim 1, wherein the safety cutting blade is asymmetric about a centerline of the stem.

11. The safety cutting blade of claim 1, wherein the safety cutting blade comprises an L-shape.

12. The safety cutting blade of claim 1, wherein the first notch has a mouth that is narrower than an interior portion of the first notch.

13. The safety cutting blade of claim 12, wherein one of a non-cutting edges of the stem is angled toward the interior portion of the first notch

14. The safety cutting blade of claim 1, further comprising a third, distinct cutting edge disposed within the first notch.

15. The safety cutting blade of claim 1, wherein the safety cutting blade substantially comprises a plastic.

16. The safety cutting blade of claim 1, wherein the safety cutting blade substantially comprises a ceramic.

17. The safety cutting blade of claim 1, wherein the safety cutting blade substantially comprises a metal.

18. The safety cutting blade of claim 1, wherein the safety cutting blade comprises a first used to form the bar, the stem, and the safety guard, and at least a second, different material.

19. The safety cutting blade of claim 18, further comprising a coating of the second material disposed over at least some surface of the safety cutting blade.

20. The safety cutting blade of claim 1, wherein the first safety guard is folded toward the stem.

21. The safety cutting blade of claim 20, wherein the first safety guard is folded with a fold angle of approximately 180 degrees.

22. The safety cutting blade of claim 1, wherein the stem, the cross bar, the first safety guard, and the first notch are generally co-planar.

23. A utility tool comprising the safety cutting blade of claim 1, where the stem of the safety cutting blade is disposed within a handle of the utility tool.

24. The utility tool of claim 23, wherein the safety cutting blade is releasably attached to the handle.

25. The utility tool of claim 24, wherein the safety cutting blade is disposed within a removable blade cartridge that couples to the handle.

26. The utility tool of claim 23, wherein the safety cutting blade and the handle comprise a unitary assembly.
